(19) United States
(12) Patent Application Publication
(10) Pub. No.: US 2004/0259399 A1
(43) Pub. Date: Dec. 23, 2004

(54) Memory card connector with card lock

(76) Inventor: Chia-Chen Chang, Hsin Chung City (TW)

Correspondence Address: MOLEX INCORPORATED, 2222 WELLINGTON COURT, LISLE, IL, 60532, US

(21) Appl. No.: 10/869,525

(22) Filed: Jun. 16, 2004

(30) Foreign Application Priority Data
Jun. 17, 2003 (TW) 92211045

(51) Int. Cl. H01R 13/62

(52) U.S. Cl. 439/159

(57) ABSTRACT

A memory card connector includes an insulative housing which at least in part defines a card-receiving space for the insertion thereinto of a memory card. A cover is positioned over at least a part of the housing. A card eject mechanism is mounted on the housing and includes a slide member movable with the memory card in an insertion/ejection direction. An elongated card locking spring member is interengageable between the slide member and the memory card and includes a fulcrum portion intermediate opposite ends of the elongated spring member and engageable with the cover to bias a locking end of the spring member into engagement with the memory card.

### FIELD OF THE INVENTION

This invention generally relates to the art of electrical connectors and, particularly, to a memory card connector having a locking member to lock the memory card in its inserted position.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

A typical memory card connector includes some form of dielectric housing which is covered by a metal shell. The metal shell may be stamped and formed of sheet metal material and formed substantially into a box-shape. The metal shell and the housing combine to define a card-receiving cavity. One end of the cavity is open to form a card-insertion opening. The dielectric housing may be generally L-shaped or U-shaped and includes a rear terminal-mounting section at the rear of the cavity, and a longitudinal side wall section extends forwardly from one or both ends of the rear section at one or both sides of the cavity. The contacts or terminals of the connector are mounted on the rear section. The metal shell has a top plate substantially covering the dielectric housing, with side plates extending downwardly over the side wall sections of the housing. The side plates of the metal shell and/or the side wall sections of the housing define the sides of the card-receiving cavity.

The memory card connector often is mounted on the top surface of a printed circuit board, and solder tail portions of the terminals are connected, as by a reflow soldering process, to appropriate circuit traces on the board. The connector often includes some form of eject mechanism to facilitate ejecting a memory card from the card-receiving cavity of the housing. The eject mechanism often is mounted on one of the side wall sections of the L-shaped or U-shaped housing.

FIGS. 1 and 2 show a typical memory card connector, generally designated 12, according to the prior art. The connector includes an insulative housing, generally designated 14, having a rear terminal-mounting section 16 and a pair of side wall sections 18 and 20 extending forwardly from opposite ends of the rear section and defining a card-receiving space 22 for insertion thereinto of a memory card in the direction of arrow “A”. A plurality of conductive terminals, generally designated 24, are mounted through rear section 16 of the housing. The terminals have contact arms 24a projecting forwardly into the card-receiving space for engaging appropriate contacts on the memory card. The connector is adapted for mounting on a printed circuit board, and terminals 24 have tail portions 24b for connection, as by soldering to appropriate circuit traces on the printed circuit board. An inverted U-shaped metal cover, generally designated 26, is mounted over the top of the housing and has a top plate 26a spanning the card-receiving space 22 as seen in FIG. 2.

Connector 12 includes a card eject mechanism, generally designated 28, mounted on side wall section 18 of the housing. The eject mechanism includes a slide member, generally designated 30. The slide member includes a body portion 32a which slides within a passage 32 in side wall section 18. The slide member has a card-engaging portion 30b which engages one corner of the memory card as the memory card is inserted into the connector and ejected therefrom.

Prior art connector 12 in FIGS. 1-3 includes a card lock member, generally designated 34, which has a fixing end 34a, a card locking end 34b and a spring arm 34c extending therebetween. The spring arm can flex within a slot 26a in a top plate 26b of cover 26. Fixing end 34a is fixed to slide member 30, and card locking end 34b is lockingly engageable in a recess 35 in a memory card “C” as seen in FIG. 3, as the card is inserted in the direction of arrow “A” into card-receiving space 22. Imaginary line 35 is a demarcation line between memory card “C” and slide member 30. One of the problems with card lock mechanisms as described above is that the fulcrum for spring arm 34c is all the way back at fixing end 34a of card lock member 34. Therefore, spring arm 34c over-flexes and results in a weak locking force applied to memory card “C”. The card lock is intended to hold the memory card in the connector with the contacts on the card in engagement with contact arms 24a of terminals 24. However, because the card lock member is weak, it often disengages from the memory card and loosens the connections with terminals 24. The present invention is directed to solving these problems.

### SUMMARY OF THE INVENTION

An object, therefore, of the invention is to provide a new and improved card lock system for a memory card connector.

In the exemplary embodiment of the invention, a memory card connector includes an insulative housing which at least in part defines a card-receiving space for the insertion thereinto of a memory card. A cover is positioned over at least a part of the housing. A card eject mechanism is mounted on the housing and includes a slide member movable with the memory card in an insertion/ejection direction. An elongated card locking spring member is interengageable between the slide member and the memory card and includes a fulcrum portion intermediate opposite ends of the elongated spring member and engageable with the cover to bias a locking end of the spring member into engagement with the memory card.

According to one aspect of the invention, the elongated card locking spring member includes opposite ends respectively engageable with the slide member and the memory card. One end of the elongated spring member is fixed to the slide member. An opposite locking end of the elongated spring member is lockable with the memory card in response to the card being inserted into the card-receiving space.

According to another aspect of the invention, the cover has a top plate which engages the fulcrum portion of the card locking spring member. The spring member includes a spring arm which extends from the fulcrum portion to the locking end of the spring member, the top plate of the cover having a slot within which the spring arm can flex.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded perspective view of a memory card connector according to the prior art;

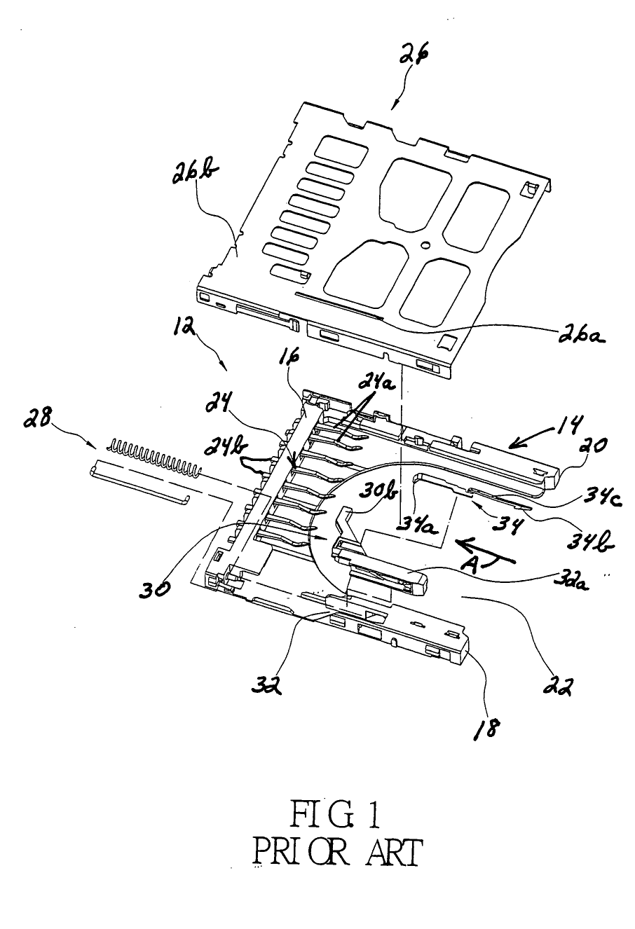

FIG. 2 is a perspective view of the prior art connector in assembled condition, with the cover lifted above the connector housing;

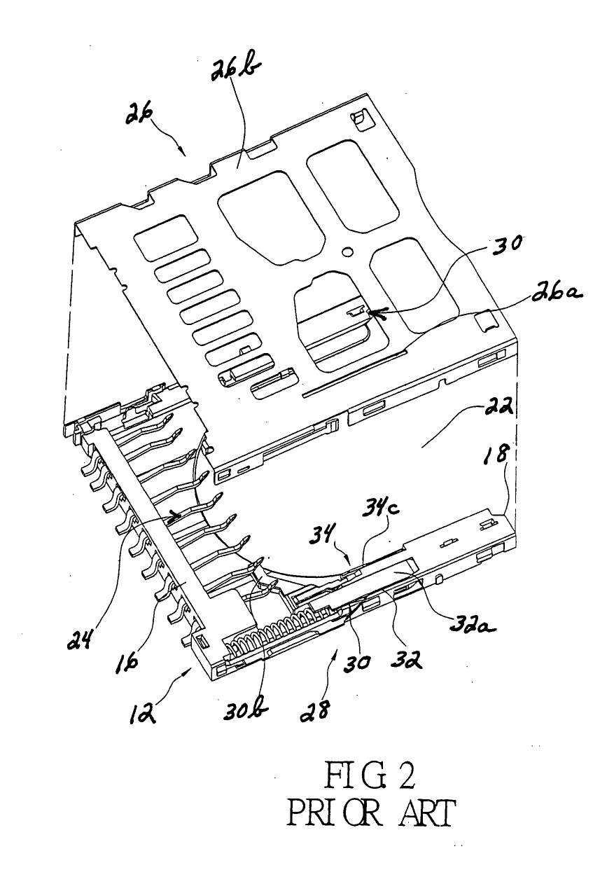

FIG. 3 is an enlarged, fragmented vertical section of the area where the card locking member interengages between the slide member of the eject mechanism and the memory card;

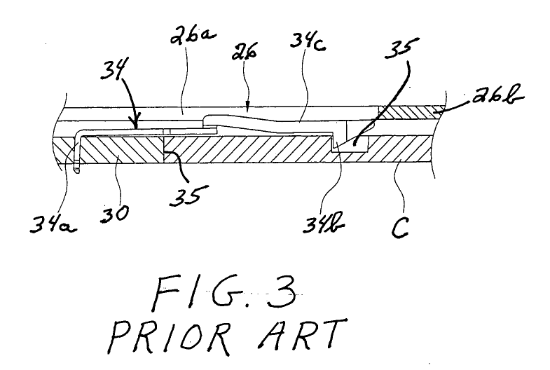

FIG. 4 is an exploded perspective view of a memory card connector according to the invention;

FIG. 5 is a perspective view of the connector of FIG. 4, in assembled condition, and with the cover lifted above the connector housing;

FIG. 6 is a view showing the underside of the cover in relation to the card locking spring member and the components of the eject mechanism; and

FIG. 7 is an enlarged, fragmented vertical section of the area where the card locking member interengages between the slide member of the eject mechanism and the memory card.

### DETAILED DESCRIPTION OF THE PREFERRED EMBODIMENTS

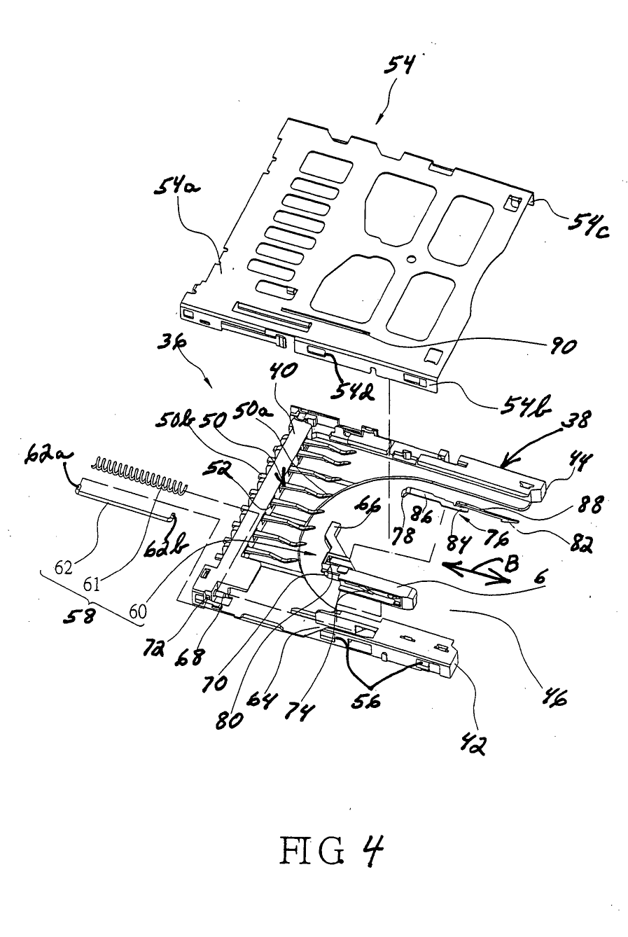

Referring to the drawings in greater detail, and first to FIG. 4, a first embodiment of the invention is shown in a memory card connector, generally designated 36. The connector includes an insulative housing, generally designated 38, having a rear terminal-mounting section 40. A pair of side wall sections 42 and 44 project forwardly from opposite ends of the rear section and define a card-receiving space 46 between the side wall sections and in front of the rear section.

A plurality of terminals, generally designated 50, are mounted within a corresponding plurality of passages 52 in rear section 40 of the housing. The terminals have elongated contact arms 50a cantilevered forwardly into card-receiving space 46 for engaging appropriate contacts on a memory card inserted and ejected into and out of the card-receiving space in an insertion/ejection direction indicated by double-headed arrow “B” (FIG. 4). Housing 38 is adapted for mounting on top of a printed circuit board, and terminals 50 have tail portions 50b for connection, as by soldering, to appropriate circuit traces on the printed circuit board.

A cover, generally designated 54, is mounted over housing 38 as shown in FIG. 4. The cover is stamped and formed of sheet metal material to provide a shield over the connector. The cover has an inverted U-shaped configuration as defined by a top plate 54a and a pair of depending side plates 54b and 54c. When the cover is mounted onto housing 38, side plates 54b and 54c of the cover overlap the outsides of side wall sections 42 and 44, respectively, of the housing, while top plate 54a of the cover spans the top of card-receiving space 46. The cover has a plurality of latch openings 54d which “snap” into latching engagement with a plurality of chamfered latch bosses 56 projecting slightly form the outside surfaces of the side wall sections of the housing. This securely latches the cover over the housing.

Connector 36 includes a card eject mechanism 58 which includes a slide member, generally designated 60, a coil spring 61 and a cam follower rod 62. Slide member 60 includes an elongated body portion 63 slidably mounted within a guide passage 64 in side wall section 42 of the housing. An eject arm 66 projects inwardly from the rear end of body portion 63 for engaging a corner of a memory card. One end of coil spring 61 is positioned over a post 68 on the housing at the rear of guide passage 64, and the opposite end of the spring is positioned over a post 70 at the rear of elongated body portion 63 of the slide member. Therefore, the coil spring is sandwiched between the housing and the slide member to bias the slide member forwardly in an ejection direction.

Eject mechanism 58 is of the “push/push” type which is well known in the art. Suffice it to say, cam follower rod 62 is generally U-shaped and has a rear end 62a which is fixedly positioned within a hole 72 at one end of rear section 42 of the housing. An opposite end 62b comprises a cam follower which rides in a heart-shaped cam groove 74 in the outside face of body portion 62 of slide member 60. In operation, a memory card is inserted into card-receiving space 46 into engagement with the slide member to push the slide member to a rear position whereat cam follower 62b rides into a particular position of cam groove 74 to latch the slide member and the memory card in its fully inserted position. A second “push” on the memory card releases cam follower 62b from its latched position within cam groove 74 to allow coil spring 61 to push the slide member outwardly and eject the memory card.

Generally, the invention contemplates the provision of a memory card locking system for locking a memory card when inserted into the connector. Specifically, and still referring to FIG. 4, an elongated card locking spring member, generally designated 76, is interengageable between slide member 60 and the memory card. The card locking spring member includes a fixing end 78 fixed in a hole 80 in the top of the slide member. A hook-shaped locking end 82 is provided for locking engagement with the memory card in response to the card being inserted into card-receiving space 46. A fulcrum portion 84 is located intermediate the fixing and locking ends of spring member 76. An elongated support arm 86 extends inwardly from fixing end 78 to fulcrum portion 84. A spring arm 88 extends inwardly from locking end 82 to fulcrum portion 84.

The elongated card locking spring member 76 is in a generally inverted U-shaped configuration with fixing end 78 bent downwardly at the rear end of support arm 86, for insertion into hole 80 in the slide member. The hook-shaped locking end 82 projects downwardly at the opposite end of the spring member. The entire elongated card locking spring member is unitary and stamped and formed of sheet metal material. Support arm 86 is elongated and generally flat, while fixing end 82 is formed as a tab bent downwardly from the rear end of the flat support arm. Fulcrum portion 84 is bent upwardly from the opposite end of support arm 86. Spring arm 88 is flat in a vertical plane, i.e., a plane generally perpendicular to the flat support arm 86. Spring arm 88 is elongated, but is offset inwardly from the support arm 86. The spring arm is free to flex within a slot 90 in top plate 54a of cover 54.

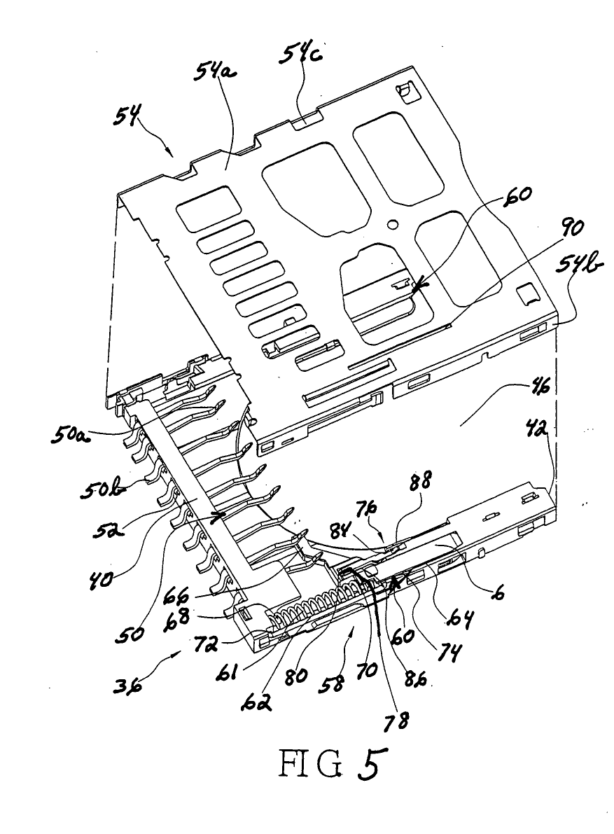

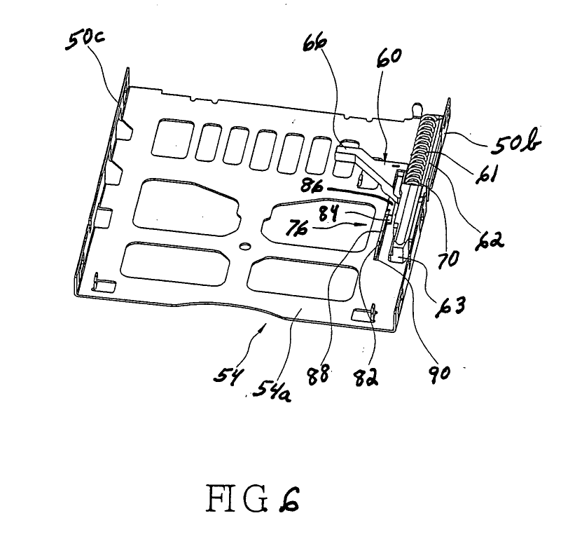

FIGS. 5 and 6 show how spring arm 88 of spring member 76 is offset inwardly relative to support arm 86. Therefore, when spring member 76 is mounted within the connector as shown in FIGS. 5 and 6, elongated support arm 86 lies under top plate 54a of cover 54. Fulcrum 84 effectively shortens spring arm 88 in comparison to the prior art, so that a strong force is provided to hold the hooked locking end 82 of the spring arm in engagement with the memory card.

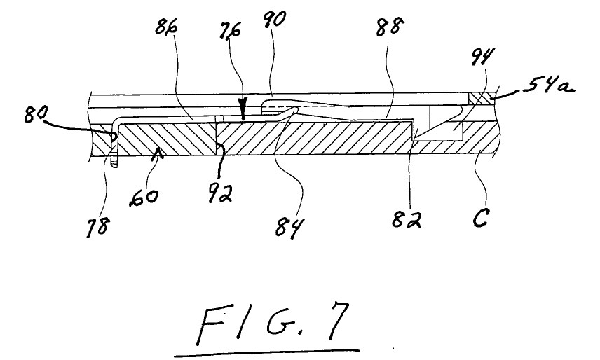

Finally, FIG. 7 shows a somewhat schematic illustration wherein line 92 is a demarcation line between memory card “C” and slide member 60. As stated above, card locking spring member is interengageable between the slide member and the memory card. It can be seen in FIG. 7 that fixing end 78 of the spring member is fixed within hole 80 in slide member 60. Locking end 82 of the spring member is locked within a recess 94 in the memory card. Spring arm 88 is free to flex within slot 90 in top plate 54a of the cover. It can be seen that locking end 82 is hook-shaped or chamfered so that the spring arm can flex upwardly into slot 90 when the memory card is inserted, and locking end 82 will “snap” into locking engagement with the memory card within recess 94. With support arm 86 and fulcrum portion 84 of the spring member being offset from spring arm 88, the support arm will be located under the top plate of the cover. Fulcrum portion 84 abuts against the underside of top plate 54a of the cover, at point 94 in FIG. 7, with spring arm 88 free to flex relative thereto.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A memory card connector, comprising:
an insulative housing which at least in part defines a card-receiving space for the insertion thereinto of a memory card;
a cover over at least a part of the housing;
a card eject mechanism mounted on the housing and including a slide member movable with the memory card in an insertion/ejection direction; and
an elongated card locking spring member interengageable between the slide member and the memory card and including
a fixing end fixed to the slide member,
a locking end for locking engagement with the memory card in response to the card being inserted into said card-receiving space,
a fulcrum portion intermediate the fixing and locking ends of the spring member, and
a spring arm extending between the locking end to the fulcrum portion,
whereby the fulcrum portion can be maintained in engagement with the cover to hold the card locking spring member in engagement with the slide member with the spring arm free to flex relative thereto.

2. The memory card connector of claim 1 wherein said cover has a top plate which engages the fulcrum portion of the card locking spring member.

3. The memory card connector of claim 2 wherein said cover includes a top plate having a slot within which the spring arm can flex.

4. The memory card connector of claim 1 wherein said elongated card locking spring member includes a support arm extending from the fixing end to fulcrum portion.

5. The memory card connector of claim 4 wherein said support arm is offset from the spring arm in a direction laterally of the longitudinal direction of the spring member.

6. The memory card connector of claim 5 wherein said elongated card locking spring member is stamped and formed of sheet metal material, said support arm is elongated and generally planar, with said fixing end bent from a distal end thereof, and said spring arm is elongated and bent into a plane generally perpendicular to the plane of the support arm.

7. The memory card connector of claim 6 wherein said fulcrum portion is bent from an end of the support arm opposite said fixing end.

8. A memory card connector, comprising:
an insulative housing which at least in part defines a card-receiving space for the insertion thereinto of a memory card;
a cover over at least a part of the housing;
a card eject mechanism mounted on the housing and including a slide member movable with the memory card in an insertion/ejection direction; and
an elongated card locking spring member between the slide member and the memory card and including a fulcrum portion intermediate opposite ends of the elongated spring member and engageable with the cover to bias a locking end of the spring member into engagement with the memory card.

9. The memory card connector of claim 1 wherein one end of the elongated card locking spring member is fixed to the slide member.

10. The memory card connector of claim 1 wherein said cover has a top plate which engages the fulcrum portion of the card locking spring member.

11. The memory card connector of claim 10 wherein said spring member includes a spring arm extending from said fulcrum portion to the locking end of the spring member for locking engagement with the memory card, the top plate of the cover having a slot within which the spring arm can flex.
